(19) United States
(12) Patent Application Publication
(10) Pub. No.: US 2025/0273811 A1
(43) Pub. Date: Aug. 28, 2025

(54) BATTERY SYSTEM WITH A BATTERY PACK ARRANGED INSIDE A COFFIN

(71) Applicant: SAMSUNG SDI CO., LTD., Yongin-si (KR)

(72) Inventor: Stefan REINPRECHT, Attendorf (AT)

(21) Appl. No.: 18/741,205

(22) Filed: Jun. 12, 2024

(30) Foreign Application Priority Data
Feb. 23, 2024 (EP) 24159483.7

(51) Int. Cl. H01M 50/383; H01M 50/293; H01M 50/367

(52) U.S. Cl. CPC H01M 50/383; H01M 50/293; H01M 50/367

(57) ABSTRACT

A battery system includes: a coffin having a battery compartment and a sand-filled compartment separated from the battery compartment; and a battery pack accommodated within the battery compartment. The battery pack includes a pack housing, a plurality of battery cells accommodated within the pack housing, and a pack venting element in the pack housing configured to exhaust venting gases from the pack housing. The sand-filled compartment forms a venting channel filled with sand and is configured to guide venting gases exhausted from the pack venting element through the sand to a venting outlet in the coffin in the event of a thermal runaway of one or more of the battery cells of the battery pack.

### CROSS REFERENCE TO RELATED APPLICATION

The present application claims priority to and the benefit of European Patent Application No. 24159483.7, filed on Feb. 23, 2024, in the European Union Intellectual Property Office, the entire disclosure of which is incorporated herein by reference.

### BACKGROUND

### 1. Field

Aspects of embodiments of the present disclosure relate to a battery system with a battery pack arranged inside a coffin.

### 2. Description of the Related Art

Recently, vehicles for transportation of goods and peoples have been developed that use electric power as a source (e.g., as a power source) for motion. An electric vehicle is an automobile that is propelled permanently or temporarily by an electric motor using energy stored in rechargeable batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries, which are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows movement of ions during charging and discharging of the battery cell. The electrode assembly is located in a casing, and electrode terminals, which are positioned on the outside of the casing, establish an electrically conductive connection to the electrodes. The casing may have, for example, a cylindrical or rectangular shape.

A battery module is formed of a plurality of battery cells connected together in series or in parallel. For example, the battery module is formed by interconnecting the electrode terminals of the plurality of battery cells in a number and in a configuration to provide a desired amount of power and to realize a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single (e.g., individual) battery cells. The battery modules, or battery cells, may be configured in a series, parallel or a mixture of both to provide the desired voltage, capacity, and/or power density. Components of a battery pack include the individual battery modules and the interconnects, which provide electrical conductivity between the battery modules.

Exothermic decomposition of cell components may lead to a so-called thermal runaway. Generally, thermal runaway describes a process that accelerates due to increased temperature, in turn releasing energy that further increases temperature. Thermal runaway occurs when an increase in temperature changes the conditions (e.g., the internal conditions of the battery cell) in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the stored energy is released very suddenly. In extreme cases, thermal runaway can cause battery cells to explode and start a fire. In minor cases, battery cells can be damaged beyond repair.

When a battery cell is heated above a critical temperature (for example, above about 150° C.), the battery cell can transition into thermal runaway. Generally, temperatures outside of the safe region on either the low or high end may irreversibly damage the battery cell and, therefore, may trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is, therefore, flammable and potentially toxic. The vented gas also causes a gas-pressure increase inside the battery pack. In the worst case, the high temperatures lead to the process spreading to neighboring cells and fire in the battery pack. At this stage, the fire is difficult to extinguish.

A battery system usually includes multiple battery packs disposed within a battery housing. Each of the battery packs includes a plurality of battery cells and is arranged inside a sealed pack housing to separate the battery cells of the battery pack from the battery cells and electrical connections of the other battery packs of the battery system.

In the case of a thermal runaway of one or more of the battery cells inside one of the battery packs, the resulting venting gases are exhausted from the battery pack via a pack vent arranged at the pack housing, thereby entering the battery housing. This may lead to heat transfer from the venting gases to the other battery packs that are disposed in the battery housing, which may damage the other battery packs. In the worst case, if the affected battery cell starts burning, the affected battery pack may cause further battery packs to go into thermal runaway due to thermal propagation.

Even if the battery system includes only one battery pack, the venting gases exhausted by the battery pack may be dangerous because they may damage any components of the battery system present outside of the pack housing or even outside the battery housing of the battery system. For example, bystanders may be injured by the hot venting gases exhausted by the battery system.

### SUMMARY

Embodiments of the present invention overcome or reduce at least some of the drawbacks of the prior art by providing a battery system including a battery pack that is sufficiently thermally isolated from the outside, for example, from other battery packs of the battery system, thereby prolonging the lifetime of the battery system.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes: a coffin having a battery compartment and a sand-filled compartment separated from the battery compartment; and a battery pack accommodated within the battery compartment. The battery pack includes a pack housing, a plurality of battery cells accommodated within the pack housing, and a pack venting element in the pack housing configured to exhaust venting gases from the pack housing. The sand-filled compartment forms a venting channel filled with sand and is configured to guide venting gases exhausted from the pack venting element through the sand to a venting outlet in the coffin in the event of a thermal runaway of one or more of the battery cells of the battery pack.

The sand in the sand-filled compartment may include or may be quartz sand.

The coffin may include outer walls made of steel.

The battery pack may further include a gas guide protruding from the pack housing and extending into the sand-filled compartment, and the pack venting element may be at an end of the gas guide inside the sand-filled compartment.

The sand-filled compartment may be arranged above the battery compartment, and the sand-filled compartment and the battery compartment may be separated from one another via a separation element that is configured to melt when exposed to venting gases leaving the battery pack at its top in case of a breakdown of a top wall of the pack housing such that the sand in the sand-filled compartment falls onto the battery pack.

The separation element may be configured to melt at a temperature between 600° C. and 1000° C.

The separation element may include an aluminum plate.

The separation element may be an aluminum sandwich plate including an upper plate, a lower plate, and a honeycomb structure between the upper plate and the lower plate.

Another embodiment of the present disclosure provides an electric vehicle including the battery system as described above.

Another embodiment of the present disclosure provides a stationary energy storage system including the battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawing, in which:

FIG. 1 is a schematic sectional view of a battery system according to an embodiment of the present disclosure.

### DETAILED DESCRIPTION

Reference will now be made, in detail, to embodiments, an example of which are illustrated in the accompanying drawing. Aspects and features of the present disclosure, and implementation methods thereof, will be described with reference to the accompanying drawing. The present disclosure, however, may be embodied in various different forms and should not be construed as being limited to the embodiment illustrated herein. Rather, this embodiment is provided as an example so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the terms “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that can be expressed by using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery system is provided. The battery system includes a plurality of battery cells arranged, for example, in a stack (e.g., in a battery cell stack), to form a battery pack. The battery cells may be prismatic battery cells. The battery cells within the battery pack may be interconnected via electrical connectors (e.g. busbars) contacting respective electrode/cell terminals of the battery cells. The battery system is an energy storage system in which electrical energy is stored within the (electrochemical) battery cells of the battery pack. The battery pack further includes a pack housing that encompasses (e.g., accommodates) the plurality of battery cells. Further, a pack venting element (e.g., a pack vent) is arranged in the pack housing, for example, in a housing wall of the pack housing, to allow venting gases that may be exhausted by one or more of the battery cells during a thermal runaway to leave (or exit) the battery pack. The pack venting element may include a venting valve. The pack venting element is configured to open (e.g., to burst) at a reference (or predefined) overpressure occurring inside the battery pack.

The battery system further includes a coffin, in which the battery pack is disposed. In more detail, the battery pack is arranged (or accommodated) inside a battery compartment of the coffin. The coffin includes, aside from the battery compartment, a sand-filled compartment. The battery compartment and the sand-filled compartment are separated from one another by a separation element, for example, by a metal plate. The compartments are separated from one another such that no gas and/or material exchange can take place between the compartments, such that—during regular (or normal) operation conditions—none of the sand in the sand-filled compartment can enter the battery compartment. The inside volume of the coffin may be divided by the separation element into two parts, which form the two compartments. The sand-filled compartment may be arranged above the battery compartment (e.g., in a gravitational direction). In such an embodiment, the separation element may be configured to carry (or support) the weight of the sand in the sand-filled compartment. Further, in such an embodiment, the separation element also shields the electrical connectors of the battery pack, which are normally located at the top side of the battery pack facing the separation element, from the sand. The separation element may be configured to position the sand in the sand-filed compartment for maximum cooling of the venting gases. In other words, the separation element may be placed (or formed) such that the sand-filled compartment forms a relatively long venting channel so that the venting gases passes through the sand over a relatively long distance, thereby transferring a lot of heat energy to the sand. The battery system may include a battery housing accommodating the coffin. Also, the battery housing may accommodate further battery packs, one or more of which may be disposed in a coffin as well. The coffin is a sealed container that seals the elements accommodated within the coffin from the outside/the environment of the coffin and the outside/the environment of the coffin from the elements accommodated within the coffin. Thus, in other words, the coffin is a sealed container. The coffin includes a venting outlet to allow the venting gases, exhausted by the battery pack into the coffin, to exit the coffin. The venting outlet may include an overpressure valve. The coffin may be made of a heat-resistant material.

The sand-filled compartment of the coffin, according to an embodiment of the present disclosure, is arranged and configured to guide the venting gases exiting the battery pack through the pack venting element to the venting outlet of the coffin. In other words, the venting gases are exhausted by the battery pack through the pack venting element into the sand-filled compartment of the coffin, pass through the sand inside the sand-filled compartment along the venting channel that is formed by the sand-filled compartment towards the venting outlet of the coffin and leave (or exit) the sand-filled compartment and, thus, the coffin through the venting outlet. The sand-filled compartment, thus, forms a venting channel for the venting gases, leading the venting gases leaving the battery pack via the pack venting element towards the venting outlet.

With the battery system, according to an embodiment of the present disclosure, the battery pack is placed inside the coffin, thereby isolating the battery pack from any other battery packs of the battery system. Venting gases exhausted by one or more of the battery cells of the battery pack during a thermal runaway are guided through the sand in the sand-filled compartment of the coffin before they leave the coffin and are thereby cooled down because heat is transferred from the venting gases to the sand. For example, the sand in the sand-filled compartment acts as a thermal mass if the battery pack goes into a thermal runaway. The sand cools the venting gases to a temperature low enough to prevent damage to any components of the battery system outside of the coffin, for example, to a temperature below about 500° C. Thus, the battery system with the sand-filled compartment may be configured to cool the venting gases to a temperature of about 500° C. or below by choosing the amount and/or type of sand and the length of the venting channel, respectively. Because the venting gases are cooled down by the sand before leaving the coffin, thermal propagation to further battery packs may be reduced and self-ignition of further battery packs may be prevented. Additionally, the sand may filter particles from the venting gases, which may contribute to the cooling and may prevent these particles damaging any external components. Also, bystanders may be protected because the venting gases exhausted from the battery system are at a lower temperature. Because the other battery packs are protected from the venting gases, the lifetime of these further battery packs and, thus, of the battery system are prolonged.

According to an embodiment of the present disclosure, the sand in the sand-filled compartment includes quartz sand. In one embodiment, all of the sand in the sand-filled compartment may be quartz sand. Quartz sand may be suited as a thermal mass, that is, as a recipient for the heat transferred from the venting gases. Also, quartz sand may be well suited for filtering particles from the venting gases.

According to an embodiment of the present disclosure, the coffin includes outer walls made of steel. A coffin with steel walls provides sufficient heat-resistance and exhibits good structural stability. Such a coffin may withstand the high temperatures of the venting gases, for example, about 1000° C. The steel coffin may, thus, maintain its structural stability and the isolation with the outside even if the venting gases should enter the battery compartment due to a failure or breakdown of the pack housing.

According to an embodiment of the present disclosure, the battery pack includes a gas guide protruding from the pack housing and extending into the sand-filled compartment. The pack venting element is disposed at the end of the gas guide inside the sand-filled compartment. In other words, the gas guide is an element of the battery pack or of the battery pack housing, which extends from the battery compartment at where the battery pack is arranged into the sand-filled compartment. The gas guide, thus, passes through the separation element separating the two compartments. For example, the separation element may include a through-hole (e.g., an opening) through which the gas guide may extend. A sealing element (e.g., a gasket) may be provided at (or in) the through-hole to seal the outer surface of the gas guide at the through-hole to maintain the separation between the two compartments and to prevent sand getting into the battery compartment. The gas guide guides the venting gases exiting the one or more battery cells during a thermal runaway away from the battery cells and into the sand-filled compartment. The venting gases may enter the sand-filled compartment after exiting through the pack venting element. This way, the venting gases are introduced into the sand-filled compartment in a relatively and mechanically simple manner.

According to an embodiment of the present disclosure, the sand-filled compartment is arranged above the battery compartment (e.g., in a gravitational direction). The arrangement “above” refers to a placement of the battery system under regular (or normal) operating conditions, for example, when mounted inside an electric vehicle. As described above, the sand-filled compartment and the battery compartment are separated from one another via a separation element. In such an embodiment, the separation element may be configured to melt when exposed to any venting gases leaving the battery pack at its top in case of a breakdown of a top wall, e.g., a cover plate, of the pack housing. During a thermal runaway affecting multiple battery cells, the temperature inside the battery pack may rise to about 1000° C. or more for a substantial (or problematic) amount of time, which may lead to a significant amount of heat energy being transferred to the pack housing and, in particular, to the top wall of the pack housing if the battery cells vent towards the top wall (e.g., if they have their venting exits at their respective tops). In the worst case, the battery pack may start burning. The top wall of the pack housing may break down under such conditions, meaning that the structural integrity of the top wall is reduced so much that venting gases leave the battery pack through the top wall and enter into the battery compartment of the coffin. The outer walls of the coffin may withstand these temperatures when they are made of steel. According to embodiments of the present embodiment, the separation element, however, cannot withstand (e.g., is configured to melt when exposed to) these temperatures but rather melts when in contact with the venting gases long enough. When the separation element melts, the sand from the sand-filled compartment may enter the battery compartment and may fall or trickle down onto the battery pack due to gravity. This may extinguish or dampen the fire in the battery pack and may limit further heat propagation. In other words, the sand may suppress flames occurring during burning of the battery pack. As long as the venting gases do not enter the battery compartment but are instead, as intended, channeled through the sand-filled compartment, the integrity of the separation element is not impaired, even when the venting gases come in contact with the separation element from the other side, because the temperature of the venting gases is lower at that point due to the heat transfer to the sand. In this embodiment, the sand-filled compartment provides two purposes: Firstly, cooling down the venting gases passing through the sand-filled compartment, and secondly, acting as a fire extinguisher if the pack housing breaks down and the battery pack starts burning. The sand falling onto the battery pack may also extinguish any electrical arcs that may occur between the cells and/or electrical connectors. Thus, the thermal isolation of the battery pack from further components of the battery system, for example, from any further battery packs, is improved.

According to an embodiment of the present disclosure, the separation element is configured to melt at a temperature between about 600° C. and about 1000° C. The material and/or structure of the separation element may be chosen to ensure that the separation element melts at the reference temperature. According to an embodiment, the separation element is or includes an aluminum plate. Aluminum has a suitable melting temperature of about 660° C. The separation element may be an aluminum sandwich plate including an upper plate, a lower plate, and a honeycomb structure between the upper plate and the lower plate. Such a separation element is suited to fulfill the above-mentioned purposes. Such a separation element will melt when in contact with the hot venting gases of about 1000° C., which leave the top side of the battery pack if the top wall of the battery pack breaks down, as described above. Further, such a separation element may provide sufficient structural integrity to carry (e.g., to support) the weight of the sand while being relatively light weight.

Embodiments of the present disclosure also pertain to an electric vehicle including a battery system according to an embodiment of the present disclosure, in which the battery system is used as a traction battery.

Embodiments of the present disclosure also pertain to a stationary energy storage system including the battery system according to an embodiment of the present disclosure. Such a stationary energy storage system may act as a local electrical energy storage, for example, to support an electrical grid. The battery system according to an embodiment of the present disclosure may be suited to be used, first, as a (traction) battery for an electric vehicle and afterwards, as a second life, as a stationary energy storage because batteries usually reach their end of life for use in electric vehicles when they reach a maximum capacity of about 80% from their original capacity. The battery system, according to embodiments of the present disclosure, however, is still suitable for other purposes, such as in the explained energy storage system to support the power grid, even after its suitable lifetime is used in electric vehicles.

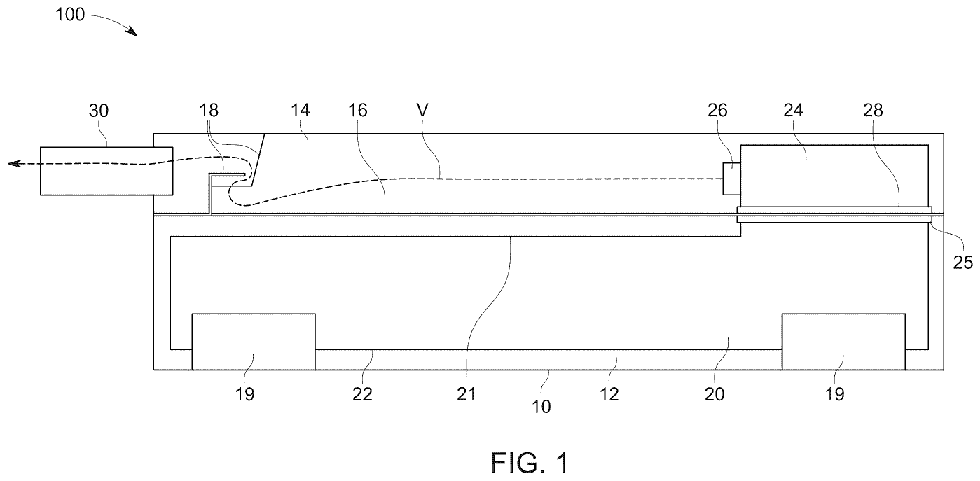

FIG. 1 is a cross-sectional view of a battery system 100 according to an embodiment of the present disclosure. The battery system 100 includes a coffin 10 having a battery compartment 12 and a sand-filled compartment 14. The battery compartment 12 and a sand-filled compartment 14 are separated from one another via a separation element 16 in the coffin 10. The separation element 16 ensures that the sand stays, during regular (or normal) operation conditions, inside the sand-filled compartment 14 and does not enter the battery compartment 12. The outer walls of the coffin 10 are made of, for example, steel. One of the outer walls of the coffin 10 has a venting outlet 30.

A battery pack 20 is accommodated within the battery compartment 12 of the coffin 10. The battery pack 20 includes a pack housing 22, a plurality of battery cells accommodated within the pack housing 22, a gas guide 24 protruding from the pack housing 22 and extending into the sand-filled compartment 14 through a through-hole (e.g., an opening) 25 in the separation element 16, and a pack venting element (e.g., a pack vent) 26 disposed at the end of the gas guide 24 in the sand-filled compartment 14. To ensure the separation between the compartments 12 and 14 via the separation element 16, the gas guide includes a seal (e.g., a gasket) 28, which seals an outer surface of the gas guide 24 in the through-hole 25 in the separation element 16. The battery pack 20 may be fixed to the coffin 10 via fixation elements 19.

FIG. 1 illustrates an embodiment of the battery system 100 having an arrangement to be mounted inside an electric vehicle or to be used as a stationary energy storage system. As can be seen in FIG. 1, the sand-filled compartment 14 is arranged above the battery compartment 12. In one embodiment, the separation element 16 consists of an aluminum sandwich plate including an upper plate, a lower plate, and a honeycomb structure between the upper plate and the lower plate. The separation element 16 is configured to melt at temperatures (e.g., when exposed to temperatures) between about 600° C. and about 1000° C., for example, at about 660° C.

The coffin 10 isolates the battery pack 20 from the outside, for example, from other components of the battery system 100, such as other battery packs. During a thermal runaway of one or more of the battery cells of the battery pack 20, venting gases exit (e.g., are vented from) the affected battery cells at their topside, flow toward a top wall 21 of the pack housing 22, along the gas guide 24, and exit the battery pack 20 via the pack venting element 26, thus, entering the sand-filled compartment 14. The sand-filled compartment 14 forms a venting channel filled with sand and is configured to guide the venting gases exhausted from the pack venting element 26 to the venting outlet 30 of the coffin 10 along a venting stream direction V as shown via the dashed arrow line in FIG. 1.

As the venting gases flow along the venting stream direction V through the sand in the sand-filled compartment 14, the venting gases transfer heat energy to the sand and are cooled. When leaving the venting outlet 30, the venting gases have cooled from a temperature of more than about 1000° C. when leaving the battery cells to a temperature below about 500° C. The venting gases exiting the venting outlet 30, therefore, no longer present a danger to components outside of the coffin 10, for example, other battery packs. Therefore, thermal propagation of the thermal runaway event to other battery packs of the battery system is prevented.

A retention element 18 may be provided at the end of the sand-filled compartment 14 at a distance to the venting outlet 30 and to ensure the sand stays inside the sand-filled compartment 14 (e.g., to prevent the sand from exiting via the venting outlet 30).

If a plurality of battery cells of the battery pack 20 experience a thermal runaway, a maximum thermal load (or maximum thermal capacity) of the top wall 21 of the pack housing 22 may be exceeded, leading to a breakdown of the top wall 21 such that venting gases exit through the top wall 21 and enter the battery compartment 12. In such a case, the venting gases having a temperature of more than about 1000° C. come into contact with the separation element 16, which causes the separation element 16 to melt. As a result, the sand trickles down from the sand-filled compartment 14 onto the top side (and onto what remains of the top wall 21) of the pack housing 22, thereby extinguishing any fire which may occur in such a situation and preventing electrical arcing between electrical connectors (e.g., busbars) of the battery pack 20, which are usually arranged at the top side.

Thus, because the battery pack 20 of the battery system 100 is sufficiently thermally isolated from other elements of the battery system 100, for example, from other battery packs, the lifetime of the battery system 100 may be improved.

Some Reference Signs

| | | | |
|---|---|---|---|
| 10 | coffin | 12 | battery compartment |
| 14 | sand-filled compartment | 16 | separation element |
| 18 | retention element | 19 | fixation elements |
| 20 | battery pack | 21 | top wall |
| 22 | pack housing | 24 | gas guide |
| 25 | through-hole | 26 | pack venting element |
| 28 | sealing | 30 | venting outlet |
| 100 | battery system | V | venting stream direction |

What is claimed is:

1. A battery system comprising:
a coffin having a battery compartment and a sand-filled compartment separated from the battery compartment; and
a battery pack accommodated within the battery compartment, the battery pack comprising a pack housing, a plurality of battery cells accommodated within the pack housing, and a pack venting element in the pack housing, the pack venting element being configured to exhaust venting gases from the pack housing,
wherein the sand-filled compartment forms a venting channel filled with sand and is configured to guide venting gases exhausted from the pack venting element through the sand to a venting outlet in the coffin in the event of a thermal runaway of one or more of the battery cells of the battery pack.

2. The battery system as claimed in claim 1, wherein the sand in the sand-filled compartment comprises quartz sand.

3. The battery system as claimed in claim 1, wherein the coffin comprises outer walls made of steel.

4. The battery system as claimed in claim 1, wherein the battery pack further comprises a gas guide protruding from the pack housing and extending into the sand-filled compartment, and
wherein the pack venting element is at an end of the gas guide inside the sand-filled compartment.

5. The battery system as claimed in claim 1, wherein the sand-filled compartment is arranged above the battery compartment, and
wherein the sand-filled compartment and the battery compartment are separated from one another via a separation element that is configured to melt when exposed to venting gases leaving the battery pack at its top in case of a breakdown of a top wall of the pack housing such that the sand in the sand-filled compartment falls onto the battery pack.

6. The battery system as claimed in claim 5, wherein the separation element is configured to melt at a temperature between 600° C. and 1000° C.

7. The battery system as claimed in claim 6, wherein the separation element comprises an aluminum plate.

8. The battery system as claimed in of claim 6, wherein the separation element is an aluminum sandwich plate comprising an upper plate, a lower plate, and a honeycomb structure between the upper plate and the lower plate.

9. An electric vehicle comprising the battery system as claimed in claim 1.

10. A stationary energy storage system comprising the battery system as claimed in claim 1.
